(19) United States
(12) Patent Application Publication
(10) Pub. No.: US 2008/0118194 A1
(43) Pub. Date: May 22, 2008

(54) Mini-plastic bearing

(76) Inventor: Shih-Jun Feng, Taichung City (TW)

Correspondence Address: BROWDY AND NEIMARK, P.L.L.C.;624 NINTH STREET, NW, SUITE 300, WASHINGTON, DC, 20001-5303, US

(21) Appl. No.: 11/729,866

(22) Filed: Mar. 30, 2007

(30) Foreign Application Priority Data
Nov. 22, 2006 (TW) 95143209

(51) Int. Cl. F16C 1/24

(52) U.S. Cl. 384/322

(57) ABSTRACT

A mini-plastic bearing of present invention makes from plastic in one unit and an axis hole is provided therein. On both side of the axis hole, there is a pivot portion annular protruding on the wall and the skirt of the pivot portion is a cambered surface. The end of the cambered surface locates on the same plate to form a pivot loop. The plate that the pivot loop locates on and the axis of the axis hole are vertical and the center of the pivot loop locates on the axis of the axis hole. A pit for storage oil is provided between two pivot portions.

### BACKGROUND OF THE INVENTION

1. Field of the Invention

The present invention relates to a bearing and more particular to a mini-plastic bearing.

2. Description of the Related Art

In prior art, there is a size limit to the bearing. The ball bearing fails to use in the product when the product becomes more and more small. For example: the mini-fan mounts in the notebook computer or the electric products that needs to face the heat problem arising from the continued upgrading microprocessor like PDA. As regards the question as aforesaid, the solution is the sleeve bearing so far. The sleeve bearing makes of metal and has plurality fillisters that extends from the bottom of the inside wall of the axis hole as an oil tank. The sleeve bearing uses oil to reduce friction and heat and to increase durability. The oil that uses in the sleeve bearing is sticky in normal time in order to prevent leak. So, the maximum static friction that needs to overcome when start up the bearing is great and the start up current and voltage are higher also. The heat that generates by the rotation of the sleeve bearing will make the oil flow easily and cause a leak problem.

### SUMMARY OF THE INVENTION

The main object of the present invention is to provide a thin, small mini-plastic bearing to meet the customer required.

The other object of the present invention is to provide a durable mini-plastic bearing.

Another object of the present invention is to provide an inexpensive mini-plastic bearing.

To achieve those objects of the present invention, a mini-plastic bearing of present invention makes from plastic in one unit and an axis hole is provided therein. On both side of the axis hole, there is a pivot portion annular protruding on the wall and the skirt of the pivot portion is a cambered surface. The end of the cambered surface locates on the same plate to form a pivot loop. The plate that the pivot loop locates on and the axis of the axis hole are vertical and the center of the pivot loop locates on the axis of the axis hole. A pit for oil storage is provided between two pivot portions.

### BRIEF DESCRIPTION OF THE DRAWINGS

FIG. 1 is a section view of present invention;

FIG. 2 is a dialog view of present invention using on a mini-fan;

FIG. 3 is an expand view of the bearing and the axis of the mini-fan in FIG. 2 of present invention;

### DETAILED DESCRIPTION OF THE INVENTION

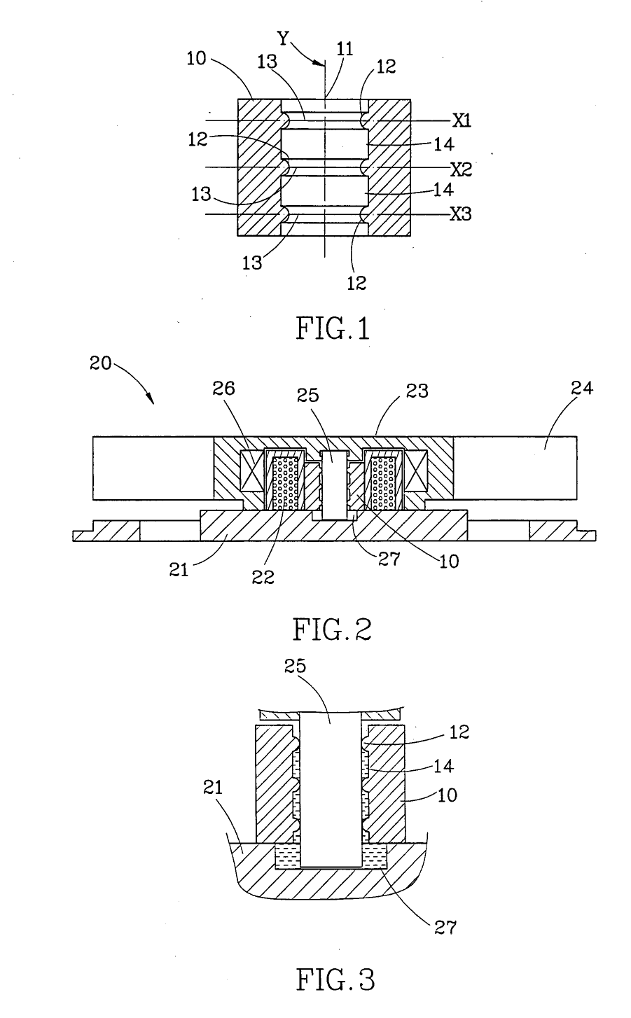

Referring to the FIG. 1, a mini-plastic bearing 10 of present invention makes from plastic in one unit and an axis hole 11 is provided therein. On both side of the axis hole, there is a pivot portion 12 annular protruding on the wall and the skirt of the pivot portion is a cambered surface. The end of the cambered surface locates on the same plate to form a pivot loop 13. The plate X that the pivot loop 13 locates on and the axis Y of the axis hole 11 are vertical. The center of the pivot loop 13 locates on the axis Y of the axis hole 11. A pit 14 for oil storage is provided between two pivot portions 12. There is one more pivot portion in the axis hole between those two pivot portions 12 in this embodiment. So, the mini-plastic bearing 10 has three pivot loops 13 therein. The plate X1, X2, X3 of each pivot loop 13 locates on and the axis Y of the axis hole are vertical. The center of each pivot loop 13 locates on the axis Y of the axis hole 11. These three pivot loops are in the same diameter and are placed in equal distance. Two pits 14 in same width are provided between those three pivot loops 13.

A pivot portion 12 is provided on each side of the axis hole in the minimum length of present invention and only a pit 14 forms between those two pivot portions 12 therein. As the length of the bearing 10 increases, more pivot portions can be provided in the axis hole 11. The number of the pivot portion depends on the length of the axis hole and the supporting required of the axis. This is a practice selection. There are three pivot portions in this embodiment. Of course, the mini-plastic bearing can has four or five or more pivot portion.

Referring to FIG. 2, this FIG. shows the structures of the mini-plastic bearing of present invention mounts on a mini-fan 20. The mark 21 shows a base, 22 shows a coil, 23 shows a rotating plate, 24 shows a vane, 25 shows a axis, 26 shows a magnet, 27 shows a fillister that places on the center of the base for oil storage.

Referring to FIG. 3, the axis of the mini-fan that makes of metal plugs into the mini-plastic bearing 10 of present invention and supports by those three pivot loops 13. There is oil in the fillister 27 of the base and the pit 14 to provide lubricant function.

The mini-plastic bearing of present invention makes from engineering plastic. Because of the engineering plastic are lubricity material and the gap between the pivot loop 13 and the axis 25 is tiny, the lubricant oil can form a membrane to seal the oil. The oil is uneasy to leak. Only a line area of the axis contacts with the pivot loops 13. So, the heat that generates by the friction is smaller and the product is durable. After six more months test, the mini-plastic bearing of present invention that mounted on a mini-fan is still rotating well. The quality of present invention is excellent.

The advantages of present invention are:

1. The bearing can be miniaturization and use in the mini-fan.

2. The oil is uneasy to leak and the product is durable.

3. The coefficient of the friction is small and the bearing can start up with a lower current and voltage. The oil can be less sticky due to the uneasy leaking structures and the start up current and voltage can be lower than prior art.

4. The cost can be reduced. The mini-plastic bearing makes of plastic by injection. So, the bearing can produce in mass production cheaply and quickly.

An additional remark, all these descriptions about that the pivot loop of present invention and the axis are vertical and the pivot loop locates on the same plate are a theory numeric. In fact, there always is some inaccuracy and the inaccuracy should be included in the area of present invention.

What is claimed is:

1. A mini-plastic bearing of present invention makes from plastic in one unit and an axis hole is provided therein, on both side of the axis hole, there is a pivot portion annular protruding on the wall and the skirt of the pivot portion is a cambered surface, the end of the cambered surface locates on the same plate to form a pivot loop, the plate and the axis of the axis hole are vertical and the center of the pivot loop locates on the axis of the axis hole, a pit for oil storage is provided between two pivot portions.

2. The bearing as claimed in claim 1, at least one more pivot portion is provided in the axis hole between those two pivot portions and the bearing can have three pivot loops at least, each plate that the pivot loop locates on and the axis are vertical and each center of the pivot loop locates on the axis.

3. The bearing as claimed in claim 2, wherein those pivot loops are placed in equal distance.

4. The bearing as claimed in claim 3, wherein those pivot loops are in the same diameter.
